(19) United States
(12) Patent Application Publication
(10) Pub. No.: US 2002/0066263 A1
(43) Pub. Date: Jun. 6, 2002

(54) DISC AND KNIFE CUTTER ASSEMBLY FOR MOWING

(76) Inventor: ROY D. MEGLI, ROCK FALLS, IL (US)

Correspondence Address: VOGT & O'DONNELL, LLP, P. O. BOX 1277, WHITE PLAINS, NY, 10601, US

(21) Appl. No.: 09/308,204

(22) PCT Filed: Nov. 14, 1997
(86) PCT No.: PCT/US97/20721

(51) Int. Cl. A01D 34/73

(52) U.S. Cl. 56/295

(57) ABSTRACT

A cutting assembly for a mowing machine has a disk (12) and a knife member assembly. The disk (12) has a surface portion (14) of which at least a peripheral portion is planar. At least three knife members (18), which have a cutting edge (50), a beveled surface portion (48) which extends from the cutting edge (50) and a body surface portion (60) which extends from the beveled surface (48), are mounted to the disk (12) at positions so that the knife members (18) are displaced substantially equidistantly one from another and so that upon rotation of the disk (12) in a plane about a central disk axis, the cutting edge (50) of the knife members (18) extends away from the disk (12), and the body surface (60) is. with respect to the disk planar surface, inclined at an angle.

### BACKGROUND OF THE INVENTION

1. Field of the Invention

The present invention relates to cutter members and assemblies for cutting machines, particularly rotary cutting machines, and more particularly to cutting assemblies having a plate so a disk and a plurality of knife members mounted therewith, particularly for use for lawn maintenance and more particularly for use in operations to provide commercial lawn-care maintenance.

2. Description of the Art

Lawnmower assemblies long have been and most commonly are constructed with a elongated bar, or arm, member which extends substantially linearly and is connected at an end-to-end and side-to-side mid-point to a rotatable means, such as is known as a spindle, which is integrated with means for providing motive driving force. In these mowers, which are known as rotary mowers, the bar member terminates at its opposing ends with beveled longitudinally-extending portions which provide cutting edges. In lawnmower models employed by the home-owner, such as push-type and walk-behind mowers, driving force is applied to rotatable means, again such as a spindle, directly by a motor. In larger-capacity, so-called riding mowers, including those employed by the home-owner and by those engaged in supplying lawn-care services commercially, means for rotating the cutting bar includes such as a spindle and also pulley and belt means interconnected with motor motive driving force.

Although mowers having one or more cutting bar members provide a generally reliable construction and generally satisfactory aesthetic results at acceptable cost, the cutting capacity of these mowers is limited by motor power which, for example, in cases wherein the grass is particularly thick, or dense, and/or in excess of about 3 inches, limits mower ground-speed. Thus, to avoid what is known as over-driving, i.e., a ground-speed at which the rotational speed of the cutter bar member capacity is insufficient to cut the grass cleanly and/or to avoid dragging down the motor, slower ground speeds must be employed to avoid matting of at least some grass, such as due to a lack of lift, and an uneven cut. So, too, when such mowing devices turn a corner, cutting effectiveness is substantially diminished and grass is inevitably cut unevenly.

Additionally, a further distinctive result of using such mowers is that the apparent color of the cut lawn, when viewed particularly from a distance, differs. That is, a cut made in one ground-travel direction presents a perception of color different from the apparent color of cuts made in different ground-travel directions, in that the cuts present dark/light contrast.

In addition to concerns of cutting capacity and aesthetics, of particular concern in the commercial lawn-care business, wherein mowers are employed for a plurality of hours each day, as opposed to only once every 10 to 14 days by a home-owner, is wear and tear and cost of maintenance. In general, it is not uncommon, even with lawns which are frequently maintained, to have to sharpen even the highest quality blades available, at least, on an average of after 20 to 30 hours of mowing time which, in a commercial operation, as will be appreciated, can lead to down-time, and care must be taken during sharpening to avoid the blades from becoming out of balance which can lead to other machine-part wear and tear.

Furthermore, in general, even the best blades available can be sharpened on the order of, at most, only about 10 to 15 times before they must be replaced, and although cutting bar member blades are available which have four cutting edges, i.e., opposing cutting edges at each end, so that they may be reversed to extend their useful life, blade replacement is not an inexpensive proposition. So, too, blade replacement may be necessitated by striking an object such as a rock, and much effort has been devoted in the art to minimize this problem.

Efforts in the mowing art to at least reduce, if not avoid, the consequences of blade damage upon encountering an obstruction extend back at least 50 years. Chadwick, U.S. Pat. No. 2,916,867, for example, discloses one such effort wherein a cutting member blade is mounted movably pivotally to each end of a bar member so that in operation, the blades are thrust into and maintained in a cutting position by centrifugal force, and if an obstruction is struck, the affected blade(s) yield(s) to minimize damage.

Others have suggested construction of a cutting assembly wherein a plurality of blades are mounted pivotally to and extend from a disk member so that, again, upon rotation of the disk, these blades are thrust and maintained in a cutting position by operation of centrifugal force and so that if an obstruction is encountered, the affected blade(s) yield(s) to minimize damage, as illustratively shown by Cauble, U.S. Pat. No. 2,529,797.

As the art also shows, however, the lift and/or throw provided by disk and cutting member designs was less than satisfactory. Thus, to address the problem, Kirk, U.S. Pat. No. 3,320,733, proposed a blade construction which has a flat blade surface and an upturned trailing edge “impeller” portion for driving cuttings out a mower housing chute portion. So, too, seeking to improve upon prior blade design such as Kirk discloses, Lindblad, U.S. Pat. No. 4,214,426, presents disclosure of a blade structure which also has a concave and convex shape to manipulate air flow further.

Another assembly along the lines of Kirk with a trailing edge impeller/deflector member is that disclosed in Goserud, U.S. Pat. No. 3,715,874, which also includes disclosure of a blade configuration wherein the blade end is rounded and downwardly turned and angled, which is said to operate to protect the blade upon encountering an obstruction.

In addition, Jacobsen, U.S. Pat. No. 2,737,772, discloses an assembly which includes a plate shaped so that the plate has a centrally disposed concentric frustoconical portion, which is said to improve air flow, and has an essentially undulated periphery which provides portions to which blades having a flat surface are affixed so that in operation, the flat surface of the blades is inclined, or pitched, relative to the horizontal, which is said to effect suction within the mower housing and improve mulching capability. Additionally, it is known that wing-like members were applied to the upper surface of the Jacobsen disk at a position adjacent cutting blades for, it is believed, further complementing/improving the air flow and/or lift or throw characteristics.

Further, in the context of the Jacobsen mulching capability, as also will be appreciated by one skilled in the art, there are a plurality of specialized blade designs which are said to improve mulching capability, and some of the designs are analogous to the deflector/impeller configurations noted above. However, even the best designed mulchers leave noticeable residue, and a significant problem which remains with mulching mowers, as well as with conventional cutting bar mowers, is that mowing under wet conditions yields clumping of the cut material and build-up on the interior of the mower cutter housing, if not machine clogging, which limits productivity, particularly in commercial lawn-care operations.

In the art area of harvesting crops such as alfalfa, clover and tall grasses, for example, assemblies including plate-like and knife-blade members also have been employed, and auxiliary devices to provide lift and propel the cut material also are employed, such as disclosed in Erhart, et al., U.S. Pat. No. 4,531,349, wherein a ramp portion is positioned adjacent the cutting knives, the ramp being inclined upwardly from a position of the knives towards the plate-like member central axis. So, too, in a commonly-assigned predecessor patent, Meek, et al., U.S. Pat. No. 3,656,284, which discloses a machine to which the improvement of Erhart is directed, it is disclosed that, analogous to the concept of Jacobsen noted above, the plate-like member is arranged so that the plane of the cutting blade knives is inclined slightly downward toward the leading edge, such as at an angle of about 5°.

As will be appreciated, solving the lift and/or throw problem with auxiliary parts adds cost to manufacture and further parts which require maintenance. Furthermore, trailing edge deflectors/impellers such as noted above, preclude providing the blade portion of the cutting knife with two opposing cutting edges so that it may be reversed when one cutting edge is too worn to use further, thus resulting in only one-half the life of a double-edge blade. Moreover, in the competitive area of commercial lawn-care maintenance, improvement in aesthetic results coupled with efficiency/productivity of cutting time is constantly sought. Hence, notwithstanding the developments in the art, further need for improvement remains.

### SUMMARY OF THE INVENTION

The present invention provides a cutting assembly which is characterized by a disk and knife member assembly wherein the disk has at least a peripheral surface portion which is planar, wherein at least three knife members having a cutting edge are mounted to the disk at positions so that the knife members are displaced substantially equidistantly one from an other and so that upon rotation of the disk in a plane about a disk central axis, the cutting edge of the knife members extends away from the disk, i.e., beyond the peripheral edge of the disk, and wherein the knife members have a body surface which extends from a beveled surface portion, which extends from the cutting edge, and are mounted so that the body surface is, with respect to the disk planar surface, inclined at an angle for propelling cut material in a direction away from the assembly. In the context of the present invention, the inclination is such that the thrust provided to propel cut material in a direction away from the assembly is greater than that compared with an assembly wherein a blade surface is not inclined.

More particularly, the assembly of the present invention is characterized by disk member which defines a planar surface which extends from the peripheral edge of the disk towards a center of the disk and by an inclined surface of the knives wherein the apex of the angle of inclination is defined at a position of the juncture of the beveled surface and inclined surface. Furthermore particularly, the disk comprises a planar surface which extends from a centrally disposed disk portion to the peripheral, or circumferential, edge of the disk, and the planar surface preferably comprises the entirety of the disk surface and extends from a centrally disposed disk aperture, and preferably, the entirety of each opposing surface of the disk is planar.

The present invention includes means for mounting the knife members to the disk so that the knife members are rigidly or pivotally mounted.

To realize further benefit of the present invention, at least four knives, as defined herein, are required.

Additionally, to achieve even further benefit, the disk of the assembly of the present invention should have a mass so that, when the assembly is rotationally accelerated, the disk operates as a fly-wheel. That is, for rotational driving force which provides for disk rotation on the order of from about 2,000 RPM to about 5,000 RPM, and particularly on the order of from about 2,500 RPM to about 4,000 RPM, the mass of the disk should be such that kinetic energy applied to the assembly is stored by the disk so that upon encountering variation of load, the assembly rotation at least tends to remain constant and upon encountering a load in excess of driving force, the assembly at least tends to minimize motor power reduction, or drag.

The present invention also provides a method/process for restructuring a mowing machine which comprises a bar cutter member and means to which the bar cutter member is affixed for rotating the bar in a plane, the means including but not limited to a spindle, comprising replacing the bar cutter member of the mowing machine with a disk and knife member assembly as defined herein.

The present invention further provides a method/process for restructuring a mowing machine which comprises a plate and knife member assembly and means to which the plate is affixed for rotating the plate in a plane, the means including but not limited to a spindle, comprising replacing the plate and knife member assembly with a disk and knife member assembly as defined herein.

The present invention additionally provides a method/process for restructuring a mowing machine which comprises a disk member having a planar surface as defined herein and which comprises knife members affixed to the disk comprising replacing the knife members with knife members as defined herein to construct an assembly as defined herein.

### DETAILED DESCRIPTION OF THE INVENTION

Although the term “disk” is intended to be interpreted herein in its normal sense of having the nature of a flat circular plate, the term is not intended to exclude the presence of additional appendages or indentations which do not detract from a disk member of an assembly in accordance with the present invention resembling a disk, and the disk member need not be circular but also may have other rounded shape, including but not limited to having or approaching an oval-shaped circumference.

In the present invention, the knife members employed comprise a blade portion and a “handle” portion. As in conventional usage of the term “knife”, the handle portion is integral with and extends from the blade portion, and the handle portion is configured, by mean such as an aperture therethrough, for mounting to the disk. The blade portion comprises two edge portions which extend in a direction, generally linearly, from the handle portion to one knife end which extends between and transversely with respect to the two edge portions, these boundaries thereby defining a blade body. The blade portion further comprises a beveled surface portion which extends from one edge portion to a body surface portion which, in turn, extends from the beveled portion. The beveled surface portion is beveled with respect to the knife edge so that the blade edge is suitable for cutting (a “cutting edge” as above), and the blade portion may comprise a second beveled surface portion which extends from the second edge to provide a second cutting edge and thereby, a two-edge blade.

Essential to achieving improved results and effects, as compared with known mowing assemblies, is a disk which comprises a planar surface which extends from the peripheral circumferential edge of the disk towards the center of the disk, and as indicated above, more preferably, the planar surface extends from the peripheral circumferential edge of the disk to a centrally disposed portion, which may include, for example, a portion out of the plane about an area for affixation to a mowing machine rotational drive means, such as a spindle. However, most preferably, the entirety of at least one of the opposing disk surfaces is planar. In all cases, however, it is necessary that the disk planar surface extends from the disk peripheral edge for a distance at least sufficient for accommodating positioning of the knife handle portion, and such should be deemed as a definition of what is meant by “at least a planar peripheral portion”.

Critical to achieving improved results and effects, as compared with known mowing assemblies, is a disk and knife configuration wherein the knife is mounted to the disk so that the blade body surface portion, as defined above, is inclined with respect to the planar disk surface, the apex of the inclination being determined at the juncture of the beveled surface portion and body surface portion and with respect to the disk planar surface.

Notwithstanding the foregoing, should the disk employed have sufficient thickness relative to blade thickness, the disk may be constructed and configured so that it provides indentations to accommodate fitting of the knife handle portions therein so that the area about the indentations and at least a peripheral portion of the disk is planar and so that blade body surface is inclined with respect to a plane of the planar disk surface. Hence, as will be appreciated, at least a peripheral planar portion which accommodates the handles and preferably, the entire surface of the disk, exclusive of the indentations for accommodating the knife handles, is planar and should not otherwise contain other irregularities, including but not limited to an undulated form, which preclude surfaces adjacent or in proximity to the knife members from being defined as forming a planar surface. Preferably, in such embodiments, at least a portion of a surface of the knife handle portions are flush with the disk planar surface.

In the most practical embodiment envisioned, however, the knife handle portion is mounted against the disk planar surface. Thus, the handle portion of the knife is configured to have a planar surface for being positioned adjacent the disk planar surface, and the blade portion is configured so that the blade body surface portion is inclined with respect to the handle planar surface and thereby, when the knife is affixed to the disk, the blade body surface portion is inclined with respect to the disk planar surface.

In general, when the assembly of the invention is affixed with a mowing machine for operation, the blades will be affixed to the disk surface which faces the ground over which the mower travels. However, the knife members may be affixed to the disk surface which faces the mowing machine, i.e., the disk surface which opposes the disk ground-facing surface, and in this case, it may be desired that only a peripheral portion of the disk sufficient to accommodate the blades be planar, but in this case also, it is preferred that the ground-facing surface be substantially entirely planar, but for possibly a central portion as noted above.

The knife members preferably are made of and comprise a rigid metallic composition including but not limited to iron and alloys thereof and steel, including but not limited to solingen steel.

The angle of inclination may be on the order of from about 3° to 20°, and preferably from about 4° to 15°, and more preferably from about 5° to 10°, and most preferably from about 6° to 9°.

Although the knife members employed may have only one blade portion cutting edge, a double-edge blade is preferred. As will be appreciated, knife members may be forged and/or tooled in a variety of configurations for mounting to achieve an assembly in accordance with the present invention wherein a blade surface portion, as defined, extends out of the plane of the planar disk surface, and the body surface portion need not be planar. The body surface portion may have a curvature which need not be uniform along a longitudinal extent of the blade portion from the handle portion to the knife member end between the blade portion edges. It may have a slight convex-to-concave shape as it extends from the handle portion to the knife end between the edges, the essential feature being, again, that the blade body surface portion extends from one point to another point displaced one-from-the-other to define a plane inclined with respect to the plane of the disk planar surface.

In the interest of construction material economy and particularly in the context of providing a double-cutting edge blade portion configured so that the central surface is inclined with respect to the handle, it is believed that the knife portion is formed best with a curvature at an area of transition between the handle and blade portions so that two opposing central body portions are formed which provide the requisite inclination. Although not required, each of two beveled portions, which provide the two cutting edges, may depend in their inclination from a common central body surface portion. Such a blade, one having some curvature and two cutting edges as described, is known and may be obtained from New Holland North America, Inc. equipment dealers, these blades having found use in a machine known as a New Holland DISC BINE mower conditioner machine.

For mounting, knife members of the assembly of the present invention are configured with such as an aperture through a portion of the handle to accommodate a mounting means, and mounting means may include any number of manners known in the art and to those skilled in the art. Means for mounting the knives may provide for rigid affixation, and thus, such may include bolting and other equivalent means which enable removal of the blades for blade replacement. Preferably, however, means for mounting the knives provide for pivoting so that upon being subjected to disk rotation, the knives are movable and are positioned for cutting by centrifugal force and so that upon a knife, or knives, striking a rigid object, a knife, or knives, at least tend(s) to yield to the object to minimize damage. Of course, as will be appreciated, should the embodiment be selected wherein a disk is supplied with indentations to accommodate the knife member handles, if it is desired that the knives be pivotable, the indentations should be of a size and configuration which allows the knives to yield at least somewhat.

Means for pivotable knife member assembly mounting may be as simple as affixing the knife member to the disk with a bolt and nut with a bushing therebetween via an aperture in the disk and in a corresponding knife handle portion aperture, so that the knife member is movable freely, as shown further below. So, too, mounting means configurations as indicated in art identified above are acceptable, and the disclosures thereof are incorporated herein by reference as if fully set forth herein.

In all embodiments, the knife members should be mounted at positions so that the at least three and preferably four knives are spaced apart so that the assembly is balanced about a disk central axis, and thus, the blades are substantially, if not exactly, spaced equidistantly apart.

The disk further is constructed for ready installation in any mowing machine for replacing cutter bar members and other plate and disk cutting assemblies, in that the disk is provided most conveniently with a centrally disposed aperture to enable affixation to means for effecting rotary drive, such as, but not limited to, a driving spindle, be it a means which is directly motor driven or which is belt and pulley or otherwise equivalently driven, including gear driven. Accordingly, the circumference of the assembly of the invention is selected to provide a cutting swath substantially equivalent with that intended by the cutting device of any particular machine. Thus, the assembly may be sized to be installed in and to meet the needs of the cutting dimensions of any particular mowing machine.

As indicated above, it is preferable that the cutting assembly of the invention have a mass which provides fly-wheel characteristics, and in this regard, the assembly has a mass in excess of that had by bar blades which it replaces. In general, the weight of the assembly preferably is on the order of at least about 1.5 times the weight of bar blades conventionally employed and preferably at least about 2 times and preferably at least about 2.5 times greater. Thus, while commercial lawn-care-type mowing machine bar blades have, for example, a weight of about 4 pounds (˜3.6 kg), the weight of the assembly of the present invention is on the order of from about 6 pounds (˜2.7 kg) to about 12 pounds (˜5.5 kg) and more preferably about 9 pounds (˜4.1 kg) to about 10 pounds (˜4.5 kg).

In general, knife member dimensions may be on the order of about 3 inches to about 6 inches (76.2 mm to 152.4 mm) in length and about 1.5 inches to about 3 inches (38.1 mm to 76.2 mm) in width to provide for a blade portion cutting edge on the order of about 1.5 inches to about 2.5 inches (38.1 mm to 63.5 mm). Knife thickness may range from about 0.06 inches to about 0.375 inches (˜1.5 mm to ˜9.5 mm). Weight of the knife member may range from about 2 oz. to about 6 oz. (57 g to 170 g) and preferably from about 3.5 oz. to about 5 oz. (99 g to 142 g).

Although disk construction with rigid plastic material such as KEVLAR and the like and rigid plastic loaded with metal to increase mass, are not intended to be excluded from the scope and embrace of the present invention, the disk is constructed preferably of metal so that sufficient weight and mass is provided, the metal preferably being a steel. Illustrative is use of steel having a thickness on the order of from about 0.080 inches to about 0.500 inches (˜2.0 mm to 12.7 mm) in general, although larger thicknesses are not intended to be precluded, and it is preferred that the disk have a thickness on the order of about 0.090 inches to about 0.300 inches (˜2.3 mm to ˜7.6 mm).

As should be appreciated, disk strength and/or yield stress is affected by the size of the circumference of the disk as is the ability to impart a fly-wheel characteristic of significance. Hence, in general, for any particular component material, as disk circumference is increased, the thickness should be increased. Additionally, the weight of the disk must be heavier than the combined weight of the blades so that the disk remains rigid and/or thereby substantially avoids being subjected to a bending moment, and it has been found that a feature of disk mass greater than knife member mass enables the assembly to remain in balance even if, for example, the knife members are not spaced apart equidistantly with perfect precision. Hence, the mass of the disk enables effects due to knife member spacing imprecision to be damped, and thus, the fly-wheel characteristic also damps possible weight differences between knife members due to wear and/or differences caused by sharpening.

Operation of a mower with an assembly of the present invention yields a plurality of results and effects different from other mowing assemblies. For example, in testing under cutting conditions and ground-speed at which the motor power of a cutter bar mower utilized for commercial lawn care operations is subjected to drag, it surprisingly has been discovered that replacement of the cutter bar with an assembly in accordance with the present invention enables attaining ground-speeds which are up to about 2½ times in excess of those which may be employed with the conventional bar blade mower without noticeable motor drag, and in addition, cutting quality is improved. Hence, improved productivity is provided.

So, too, it has been found that the assembly of the invention cuts cleanly and evenly when turning corners and further, differences between the color of swaths cut in opposing directions is not noticeably apparent to the naked eye.

Additionally, it surprisingly has been found that utilization of an assembly in accordance with the present invention in place of a conventional cutter bar on a mowing machine results in less stress, and hence less wear, on the rotational drive means, e.g., a spindle, and hence on the bearings for such as a spindle, as compared with that imparted by the bar cutter.

Moreover, it has been found that, in operation, the assembly of the present invention operates to re-cut already cut material and thereby provides a mulching feature without auxiliary equipment, without other specialized blade configuration, and without closing off the cut material outlet chute of conventional mowing machines. However, also, when the assembly of the present invention is employed, the mulching capability is improved and enhanced further by closing the outlet chute, and this enhanced capability is achieved without noticeable loss of motor power efficiency.

Further, tests carried out with a closed outlet chute show that the present invention provides further improved mulching efficiency. In this regard, a mower equipped with LESCO GATOR blades manufactured by Lesco, Inc., which are believed to be the state of the art, is first used to cut a swath and then, the GATOR blades are replaced with an assembly of the present invention, and a second swath is cut. Substantially less noticeable ground residue is present after cutting with the assembly of the present invention than with the LESCO GATOR blades.

Furthermore, it also surprisingly has been found that the assembly of the present invention enables mowing wet grass without clumping of the cut grass and without machine clogging, which is a principal hindrance to commercial lawn care productivity and operation under wet lawn conditions, and it has been found that the housing also stays remarkably clean in that the amount of cuttings adhering to the housing interior are substantially less than is the case with conventional cutting assemblies.

The invent on is further described with reference to the accompanying drawing Figures, and the description below is presented to show, illustratively, a configuration which operates to achieve the results, effects and advantages described above and should not in any sense be deemed as limiting the scope of the present invention.

### BRIEF DESCRIPTION OF THE DRAWING FIGURES

FIG. 1 illustrates an exploded perspective view of an assembly according to the present invention.

FIG. 2 illustrates a perspective view of a knife member configuration of an assembly according to the present invention.

FIG. 3 illustrates an end view of a knife for use in an assembly according to the present invention.

### DETAILED DESCRIPTION OF THE INVENTION

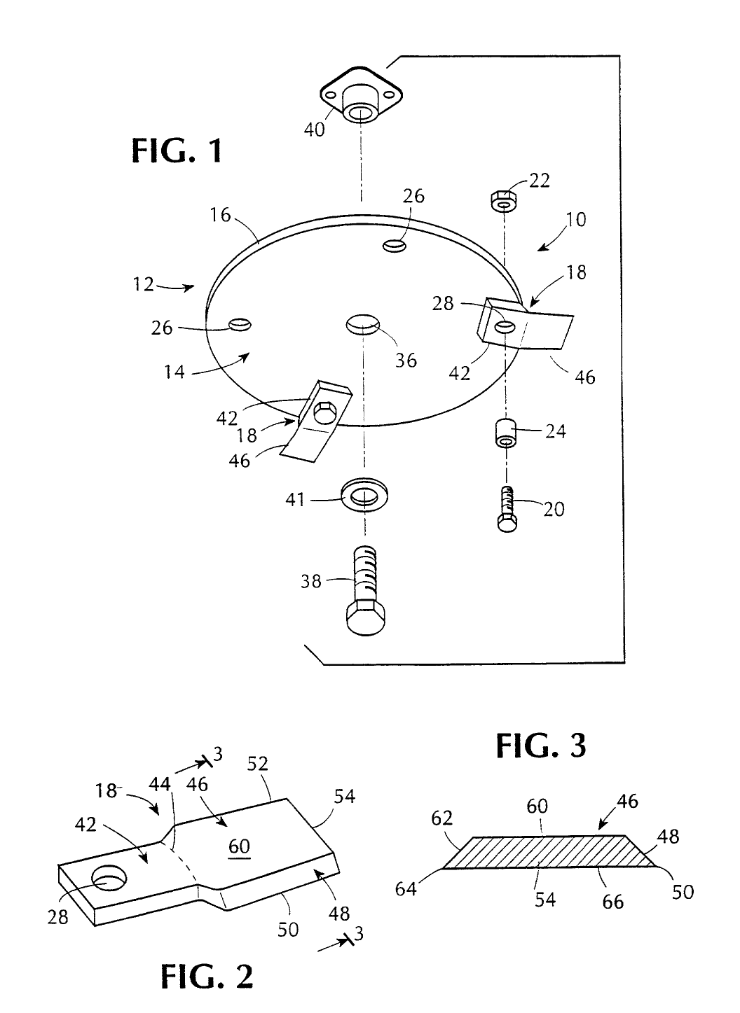

An assembly according to the present invention is illustrated in an exploded perspective in FIG. 1 and is designated generally and collectively by reference numeral 10.

Although the illustration of FIG. 1 only shows disk 12 as having planar surface 14 which extends from peripheral disk edge 16, as is preferred in accordance with the present invention, the opposing surface of disk 12 also may be understood to be entirely planar. As indicated by the exploded view, knife members 18 are to be mounted adjacent lower planar surface 14. Mounting means include bolt 20 and nut 22 and bushing 24 which are sized and configured, together with disk apertures 26 (4 in number) and knife aperture 28, so that knife 18 is pivotally movable so that upon rotation of the disk, the knife is thrust and maintained in a cutting position by centrifugal force.

As will be noted, disk apertures 26 are spaced at distances so that adjacent knife members are positioned substantially equidistantly apart one from the other. Disk 12 is provided further with centrally disposed aperture 36 which is sized to accommodate bolt 38 which, in turn, is sized to engage fixedly threads of spindle 40 which is integral with a mowing machine and its drive means, indicated and represented by a labeled box, for driving disk 12. A washer 41 may be employed between the head of bolt 38 and disk surface 14. As will be appreciated, the spindle and bolt 38 should be threaded, as should bolts 20, relative to direction of rotation so that the bolts remain tight during rotation.

Knife member(s) 18 is illustrated in each of FIGS. 1 and 2 as comprising handle portion 42 which has a planar surface portion in the area surrounding aperture 28. Knife member handle portion 42 extends from aperture 28 to a somewhat curved portion 44, which defines an area of transition (dashed line) between handle portion 42 and blade portion 46, the distinction between blade portion 46 and handle portion 42 being seen more readily at the juncture (44) of handle portion 42 and blade portion beveled surface 48, which trails from cutting edge 50. As will be noted, a second blade edge 52 opposes cutting edge 50, and knife end 54 extends transversely between the opposing edges.

The blade body surface which is inclined is designated in FIG. 2 by reference numeral 60, and the inclination may be seen by the view of knife end 54 in drawing FIG. 3, that Figure, in sum thereby also presenting a cross-sectional view of blade portion 46 of FIG. 1. As is preferred, and as illustrated in FIG. 3, the blade is provided with two beveled surfaces 48, as in FIG. 1, and 62 and two cutting edges 50, as in FIG. 2, and 64, and the blade portion also is configured so that upon wearing down cutting edge 50 upon its use as a leading edge for cutting and turning the knife over for use as a leading cutting edge, surface 66 is likewise inclined in accordance with the present invention. Thus, additionally, both opposing surfaces of knife handle 42 which surround aperture 28 (FIG. 2) should, in this embodiment, be planar for surface-to-surface-contact with a planar disk surface in an intimate manner.

As may be gathered from the foregoing drawing description and in view of the present conventional construction of mowing machines, particularly those employed for home-owner use and for commercial lawn-care maintenance, replacement of cutter means heretofore employed with an assembly according to the present invention and/or reconfiguring a prior cutter means to be in accord with the present invention, so that a mower drives an assembly as defined herein, is a relatively simple matter.

As also is clear from the foregoing, various modifications of the present invention may be made without departure from the spirit and scope of the disclosure, and the invention may be embodied suitably in the absence of elements or members not specifically disclosed herein.

I claim:

1. A cutting assembly for a mowing machine comprising:
a disk which comprises a surface of which at least a peripheral portion is planar; and
at least three knife members mounted to the disk, wherein each knife member comprises a cutting edge, a beveled surface portion which extends from the cutting edge, and a body surface portion which extends from the beveled surface portion and wherein the knife members are mounted to the disk at positions so that the knife members are displaced substantially equidistantly one from another and so that upon rotation of the disk in a plane about a disk central axis, the cutting edge of the knife members extends away from the disk and wherein the body surface is, with respect to the disk planar surface, inclined at an angle for propelling cut material in a direction away from the assembly.

2. An assembly according to claim 1 wherein the disk surface is planar from a peripheral disk edge to a centrally disposed disk portion.

3. An assembly according to claim 1 wherein the entirety of the disk surface is planar.

4. An assembly according to claim 1 wherein two opposing surfaces of the disk are planar.

5. An assembly according to claim 1 wherein four knives are mounted to the disk.

6. An assembly according to claim 1 wherein an apex of an angle of the inclination is at a position of a juncture of the beveled surface and the body surface.

7. An assembly according to claim 1 or 6 wherein an angle of the inclination is from about 4° to about 15°.

8. An assembly according to claim 1 or 6 wherein the knife member has a handle portion and a blade portion, wherein the handle portion is mounted to the disk and wherein the handle portion has a planar surface and the planar surface is mounted adjacent the disk planar surface.

9. An assembly according to claim 7 wherein the knife member has a handle portion and a blade portion, wherein the handle portion is mounted to the disk and wherein the handle portion has a planar surface and the planar surface is mounted adjacent the disk planar surface.

10. A cutting assembly for a mowing machine comprising:
a disk which comprises a surface which extends in a plane from a peripheral disk edge to a centrally disposed disk portion; and
at least three knife members mounted to the disk, wherein each knife member comprises a handle portion having a planar surface, a blade portion which extends from the handle portion and which comprises a cutting edge, a beveled surface portion which extends from the cutting edge, and a body surface portion which extends from the beveled surface portion and wherein the handle portion is mounted to the disk planar surface so that the planar handle portion is adjacent the disk planar surface and so that upon rotation of the disk in a plane about a disk central axis, the blade extends away from the disk and wherein the blade body surface is, with respect to the disk planar surface, inclined at an angle.

11. An assembly according to claim 10 wherein the entirety of the disk surface is planar.

12. An assembly according to claim 10 wherein two opposing surfaces of the disk are planar.

13. An assembly according to claim 10 wherein four knives are mounted to the disk.

14. An assembly according to claim 10 wherein an apex of an angle of the inclination is at a position of a juncture of the beveled surface and the body surface.

15. An assembly according to claim 10 or 14 wherein an angle of the inclination is from about 40 to about 15°.

16. A process for restructuring a mowing machine which comprises a cutter means selected from the group consisting of (i) a bar cutter member and (ii) a plate and knife member assembly and which comprises means for rotating the cutter means comprising replacing the cutter means with an assembly comprising:
a disk which comprises a surface of which at least a peripheral portion is planar; and
at least three knife members mounted to the disk, wherein each knife member comprises a cutting edge, a beveled surface portion which extends from the cutting edge, and a body surface portion which extends from the beveled surface portion and wherein the knife members are mounted to the disk at positions so that the knife members are displaced substantially equidistantly one from another and so that upon rotation of the disk in a plane about a disk central axis, the cutting edge of the knife members extends away from the disk and wherein the body surface is, with respect to the disk planar surface, inclined at an angle for propelling cut material in a direction away from the assembly.

17. A process for restructuring a mowing machine which comprises a disk member having a planar surface and knife members affixed thereto comprising replacing the knife members with knife members which comprise a cutting edge, a beveled surface portion which extends from the cutting edge, and a body surface portion which extends from the beveled surface portion so that when mounted, the body surface is, with respect to the disk planar surface, inclined at an angle.

18. An assembly according to claim 16 or 17 wherein an apex of an angle of the inclination is at a position of a juncture of the beveled surface and the body surface.

19. An assembly according to claim 18 wherein an angle of the inclination is from about 4° to about 15°.

20. An assembly according to claim 19 wherein the knife member has a handle portion and a blade portion, wherein the handle portion is mounted to the disk and wherein the handle portion has a planar surface and the planar surface is mounted adjacent the disk planar surface.
